(19) United States
(12) Patent Application Publication
(10) Pub. No.: US 2024/0322451 A1
(43) Pub. Date: Sep. 26, 2024

(54) ASYMMETRIC CHEBYSHEV ARRAY ANTENNA

(71) Applicant: ARCADYAN TECHNOLOGY CORPORATION, HSINCHU CITY (TW)

(72) Inventors: Shih-Chieh Cheng, HSINCHU CITY (TW); Shin-Lung Kuo, HSINCHU CITY (TW)

(21) Appl. No.: 18/613,378

(22) Filed: Mar. 22, 2024

(30) Foreign Application Priority Data
Mar. 25, 2023 (TW) 112111375

(51) Int. Cl. H01Q 21/06; H01Q 9/04; H01Q 21/00

(52) U.S. Cl. CPC H01Q 21/065; H01Q 9/045; H01Q 21/0075

(57) ABSTRACT

Provided is an asymmetric Chebyshev array antenna, comprising a substrate, a power divider, a ground plane, and a serial antenna unit. The serial antenna unit includes at least one middle radiating element, a plurality of first radiating elements, and a plurality of second radiating elements. An original current value of the middle radiating element is defined as A, original current values of the first radiating elements from a first end toward a second end of the serial antenna unit are defined as B₁, B₂, . . . , Bₙ, original current values of the second radiating elements from the second end toward the first end of the serial antenna unit are defined as C₁, C₂, . . . , Cₙ, a sum of original current values of the power divider and the ground plane is defined as D, current compensation values of the second radiating elements from the second end toward the first end of the serial antenna unit are defined as δ₁, δ₂, . . . , δₙ, n≥1 and n is a positive integer, Bₙ=Cₙ, D<B₁<B₂< . . . <Bₙ<A, D<C₁+δ₁<C₂+δ₂< . . . <Cₙ+δₙ<A, and Σᵢ₌₁ⁿ δᵢ=δ₁+δ₂+ . . . +δₙ≅D.

### CROSS-REFERENCE TO RELATED APPLICATION

This application claims the priority of Taiwanese patent application No. 112111375, filed on Mar. 25, 2023, which is incorporated herewith by reference.

### BACKGROUND OF THE INVENTION

### 1. Field of the Invention

The present invention generally relates to an array antenna, particularly an asymmetric Chebyshev array antenna.

### 2. The Prior Arts

In order to improve driving safety, modern vehicles are equipped with blind spot detection, lane switching assistance, automatic distance control cruise, parking assistance, automatic braking, collision warning, lane departure detection, and other systems. The above systems are usually equipped with a vehicle radar, which can accurately and reliably detect and locate surrounding objects in any environment. The vehicle radar includes an antenna. The antenna usually uses the principle of Frequency Modulated Continuous Wave (FMCW) to detect the distance and speed of the target to support the frequency band of the vehicle radar.

The narrower the beam of the array antenna in the radar, the higher the power will be and the farther the sensing distance. The radiation pattern synthesized by the array antenna includes the main beam (also called the main lobe) and side beam (also called the side lobe). The main beam is the area around the maximum radiation direction. Usually, the area within 3 dB of the peak of the main beam is the main working direction of the radar. Side lobes are beams with smaller radiation around the main beam. These side lobes are usually undesired radiation directions, which will cause problems such as noise interference and ghost spots in detection.

Because the array antenna can shape a desired pattern by adjusting the spacing and excitation among a plurality of radiating elements, the array antenna is very popular. When an array antenna is used in radar, the array antenna needs the highest main beam directivity, and the lowest side lobes, and the above two goals are usually a trade-off. Chebyshev polynomials enable the array antenna to obtain an idealized pattern, which means that “the radiating elements present a symmetrical distribution.” An idealized array antenna can achieve the following optimal results: firstly, under a certain side lobe level, the main beam has the highest directivity; secondly, all side lobes have the same level.

The number of radiating elements can be determined for a particular antenna size. The number of radiating elements of an array antenna is proportional to the peak gain, but more radiating elements mean a larger size printed circuit board. In other words, the number of radiating elements of the array antenna needs to be evaluated according to the size of the printed circuit board. The side lobe level is inversely proportional to directivity, and the best side lobe level results in lower directivity or lower peak gain. When the side lobe level and the number of radiating elements are determined, the size of each radiating element can be roughly obtained. Array antennas for long- or medium-range radars usually use a series of radiation combinations to increase peak gain in a small printed circuit board. Therefore, the array antenna needs a power divider for each column of radiation combinations.

However, the aforementioned idealized array antenna cannot achieve the aforementioned optimal results because: firstly, the ground plane material is metal, leading to current flow and the generation of radiation effects, which can disrupt the radiation field pattern of the array antenna; secondly, the power divider can also generate radiation effects, potentially altering the radiation pattern of the array antenna. After the radiation pattern is destroyed, there will be two peaks, and there will be a depression between the two peaks. The directivity of the main beam will decrease (that is, the gain will decrease) while the gain of the side lobe will simultaneously increase, resulting in a reduction in target detection resolution.

### SUMMARY OF THE INVENTION

A primary objective of the present invention is to provide an asymmetrical Chebyshev array antenna, which can perform current compensation on the radiating elements located at the ends of the serial antenna units, and improve the identification rate of object detection.

In order to achieve the foregoing objective, the present invention provides an asymmetrical Chebyshev array antenna, which includes a substrate, a power divider, a ground plane, and a plurality of serial antenna units. The substrate has a first surface and a second surface, and the second surface is located on the opposite side of the first surface. The power divider is disposed on the first surface of the substrate. The ground plane is disposed on the second surface of the substrate. The serial antenna units are arranged at intervals on the first surface of the substrate, and each serial antenna unit includes a plurality of feeding lines and a plurality of radiating elements and the power divider and the radiating elements are connected in series through the feeding lines.

Wherein, the end of each serial antenna unit close to the power divider is defined as a first end, and the end of each serial antenna unit away from the power divider is defined as a second end, and the radiating elements include at least one middle radiating element, a plurality of first radiating elements, and a plurality of second radiating elements, at least one middle radiating element is located in the middle of each of the serial antenna units, and the first radiating elements are located between the first end of each serial antenna units and the at least one middle radiating element, the second radiating elements are located between the second end of each serial antenna unit and the at least one middle radiating element.

Wherein, the original current value of the at least one middle radiating element is defined as A, the original current values of the first radiating elements increase gradually along a direction from the first end of each serial antenna unit to the second end of each serial antenna unit and are sequentially defined as B₁, B₂, . . . , Bₙ, the original current values of the second radiating elements gradually increase along a direction from the second end of each serial antenna unit to the first end of each serial antenna unit and are sequentially defined as C₁, C₂, . . . , Cₙ, the sum of the original current values of the power divider and the ground plane is defined as D, and the current compensation values of the second radiating elements from the second end of each serial antenna unit to the first end of each serial antenna unit are sequentially defined as δ₁, δ₂, . . . , δₙ, where n≥1 and n is a positive integer.

Wherein, the relationship between the original current values of the first radiating elements and the original current values of the second radiating elements is as follows: Bₙ=Cₙ; the relationship of the sum of the original current values of the power divider and the ground plane, the original current values of the first radiating elements, and the original current value of the at least one middle radiating element is as follows: D<B₁<B₂< . . . <Bₙ<A; the relationship of the sum of the original current value of the power divider and the ground plane, the compensated current values of the second radiating elements, and the original current value of the at least one middle radiating element is as follows: D<C₁+δ₁<C₂+δ₂< . . . <Cₙ+δₙ<A; the relationship of the sum of the original current values of the power divider and the ground plane and the current compensation values of the second radiating elements is as follows: Σᵢ₌₁ⁿ δ₁=δ₁+δ₂+ . . . +δₙ≅D.

In a preferred embodiment, the area of the at least one middle radiating element is the largest, and areas of the first radiating elements gradually increase along a direction from the first end of each serial antenna unit to the second end of each serial antenna unit, areas of the second radiating elements gradually increase along a direction from the second end of each serial antenna unit to the first end of each of the serial antenna units, the current values of the radiating elements are proportional to the areas of the radiation elements; the current compensation values of the second radiation elements are controlled by adjusting the areas of the second radiation elements.

In a preferred embodiment, each radiating element is rectangular, a length of each radiating element is parallel to a length direction of each serial antenna unit, and a width of each radiating element is parallel to a width direction of each serial antenna unit; by adjusting the width of the second radiating elements to adjust the areas of the second radiating elements, the current compensation values of the second radiating elements can be obtained.

In a preferred embodiment, the radiating elements include two middle radiating elements, three first radiating elements, and three second radiating elements; wherein, the original current values of the first radiating elements along the direction from the first end of each serial antenna unit to the second end of each serial antenna unit are sequentially defined as B₁, B₂, B₃, the original current values of the second radiating elements along a direction from the second end of each serial antenna unit to the first end of each serial antenna unit and are sequentially defined as C₁, C₂, C₃, and the current compensation values of the second radiating elements from the second end of each serial antenna unit to the first end of each serial antenna unit are sequentially defined as δ₁, δ₂, δ₃, and n=3, wherein the relationship of the original current values of the first radiating elements and the original current values of the second radiating elements is as follows: B₁=C₁, B₂=C₂, and B₃=C₃; wherein the relationship of the sum of the original current values of the power divider and the ground plane, the original current values of the first radiating elements and, the original current value of the at least one middle radiating element is as follows: D<B₁<B₂<B₃<A; the relationship of the sum of the original current value of the power divider and the ground plane, the compensated current values of the second radiating elements, and the original current value of the at least one middle radiating element is as follows: D<C₁+δ₁<C₂+δ₂<C₃+δ₃<A; the relationship of the sum of the original current values of the power divider and the ground plane and the current compensation values of the second radiating elements is as follows: Σᵢ₌₁³ δᵢ=δ₁+δ₂+δ₃≅D.

In a preferred embodiment, the radiating elements include two middle radiating elements, two first radiating elements, and two second radiating elements; wherein, the original current values of the first radiating elements along the direction from the first end of each serial antenna unit to the second end of each serial antenna unit are sequentially defined as B₁, B₂, the original current values of the second radiating elements along a direction from the second end of each serial antenna unit to the first end of each serial antenna unit and are sequentially defined as C₁, C₂, and the current compensation values of the second radiating elements from the second end of each serial antenna unit to the first end of each serial antenna unit are sequentially defined as δ₁, δ₂, and n=2, wherein the relationship of the original current values of the first radiating elements and the original current values of the second radiating elements is as follows: B₁=C₁ and B₂=C₂; wherein the relationship of the sum of the original current values of the power divider and the ground plane, the original current values of the first radiating elements and the original current value of the at least one middle radiating element is as follows: D<B₁<B₂<A; the relationship of the sum of the original current value of the power divider and the ground plane, the compensated current values of the second radiating elements, and the original current value of the at least one middle radiating element is as follows: D<C₁+δ₁<C₂+δ<A; the relationship of the sum of the original current values of the power divider and the ground plane and the current compensation values of the second radiating elements is as follows:

$${\sum }_{i = 1}^{2} {δ}_{i} = {δ}_{1} + {δ}_{2} ≅ D .$$

The effect of the present invention is as follows: the asymmetrical Chebyshev array antenna of the present invention can perform current compensation on the second radiating elements located at the end (i.e., the second end) of the serial antenna units so that the current values of each radiating element of the serial antenna units show an asymmetric distribution, which improves the identification rate of object detection.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of an asymmetric Chebyshev array antenna of the present invention;

FIG. 2 is a schematic view of the serial antenna unit in an area II of FIG. 1;

FIG. 3 is a schematic view of the serial antenna unit in an area III of FIG. 1; and

FIG. 4 is a radiation pattern diagram of an idealized array antenna of the prior art and an asymmetric Chebyshev array antenna of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

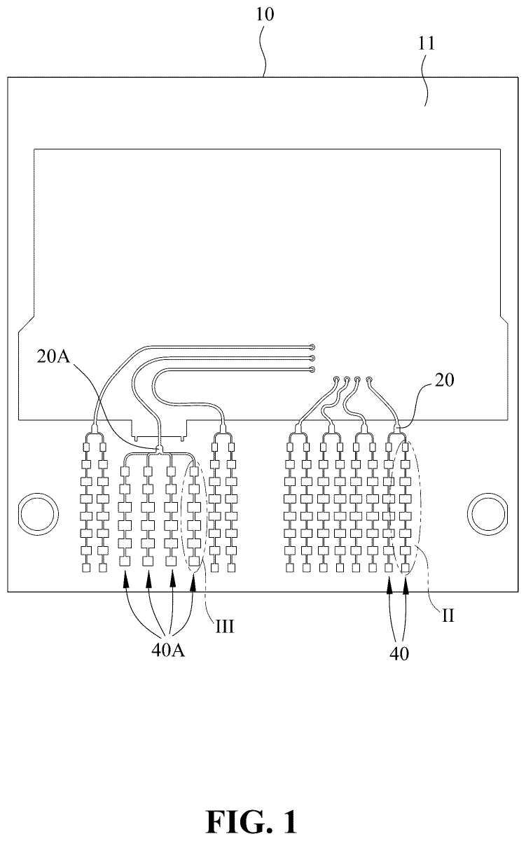

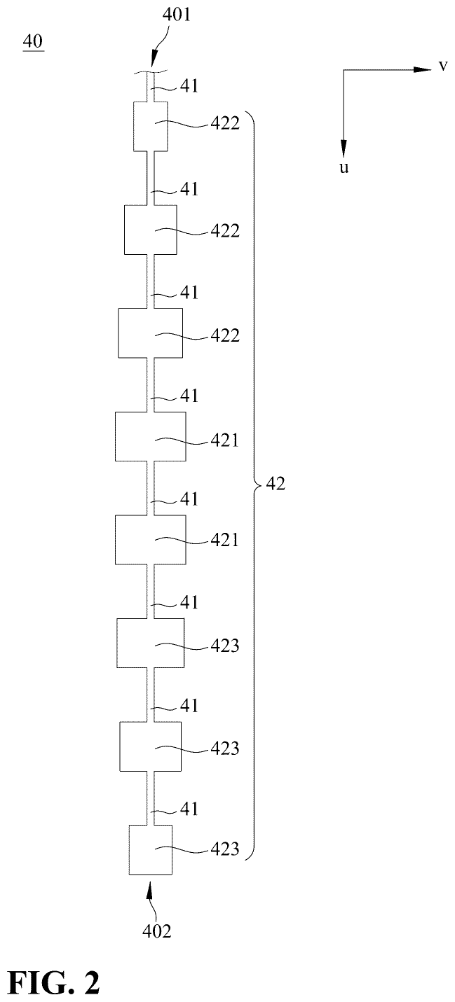

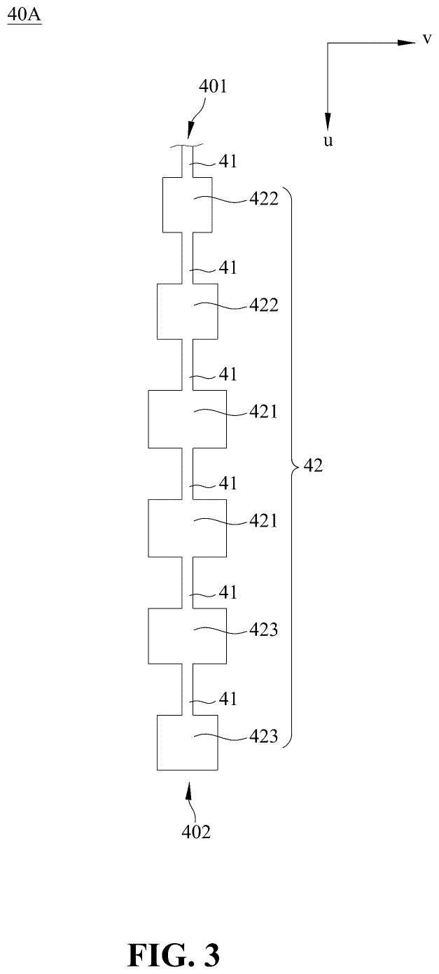

FIG. 1 is a schematic view of the asymmetrical Chebyshev array antenna of the present invention, FIG. 2 is a schematic view of the serial antenna unit 40 in an area II of FIG. 1, and FIG. 3 is a schematic view of the serial antenna unit 40A in an area III of FIG. 1. As shown in FIG. 1, FIG. 2, and FIG. 3, the present invention provides an asymmetrical Chebyshev array antenna, including a substrate 10, power dividers 20, 20A, a ground plane (not shown), and a plurality of serial antenna units 40, 40A. The substrate 10 has a first surface 11 and a second surface (not shown), and the second surface is located on the opposite side of the first surface 11. The power dividers 20 and 20A are arranged on the first surface 11 of the substrate 10, and the ground plane is arranged on the second surface of the substrate 10. The serial antenna units 40 and 40A are arranged at intervals on the first surface 11 of the substrate 10, and each serial antenna unit 40 and 40A includes a plurality of feeding lines 41 and a plurality of radiating elements 42. The power dividers 20, 20A, and the radiating elements 42 are connected in series through the feeding lines 41.

The first end 401 of each serial antenna unit 40, 40A is defined as the end proximate to the power divider 20, 20A, while the second end 402 of each serial antenna unit 40, 40A is defined as the end distant from the power divider 20, 20A. The radiating elements 42 include at least one middle radiating element 421, a plurality of first radiating elements 422, and a plurality of second radiating elements 423. The at least one middle radiating element 421 is located in the middle of each serial antenna unit 40, 40A, the first radiating elements 422 are located between the first end 401 of each serial antenna unit 40, 40A and the at least one middle radiating element 421, and the second radiating elements 423 are located between the second end 402 of each serial antenna unit 40, 40A and the at least one middle radiating element 421.

An original current value of the at least one middle radiating element 421 is defined as A, the original current values of the first radiating elements 422 gradually increase along a direction from the first end 401 of each serial antenna unit 40, 40A to the second end 402 of each serial antenna unit 40, 40A and are sequentially defined as B₁, B₂, . . . , Bₙ, the original current values of the second radiating elements 423 gradually increase along a direction from the second end 402 of each serial antenna unit 40, 40A to the first end 401 of each serial antenna unit 40, 40A and are sequentially defined as C₁, C₂, . . . , Cₙ, a sum of the original current values of the power divider 20, 20A, and the ground plane is defined as D, and the current compensation values of the second radiating elements 423 from the second end 402 of each serial antenna unit 40, 40A to the first end 401 of each serial antenna unit 40, 40A are sequentially defined as δ₁, δ₂, . . . , δₙ, where n≥1 and n is a positive integer.

The relationship between the original current values of the first radiating elements 422 and the original current values of the second radiating elements 423 is as follows: Bₙ=Cₙ; the relationship of the sum of the original current values of the power divider 20, 20A, and the ground plane, the original current values of the first radiating elements 422, and the original current value of the at least one middle radiating element 421 is as follows: D<B₁<B₂< . . . <Bₙ<A; the relationship of the sum of the original current value of the power divider 20, 20A, and the ground plane, the compensated current values of the second radiating elements 423, and the original current value of the at least one middle radiating element 421 is as follows: D<C₁+δ₁<C₂+δ₂< . . . <Cₙ+δₙ<A; the relationship of the sum of the original current values of the power divider 20, 20A, and the ground plane and the current compensation values of the second radiating elements 423 is as follows:

$${\sum }_{i = 1}^{n} {δ}_{i} = {δ}_{1} + {δ}_{2} + … + {δ}_{n} ≅ D .$$

In summary, the asymmetrical Chebyshev array antenna of the present invention can perform current compensation on the second radiating elements 423, and the compensated current values of the second radiating elements 423 remain gradually increasing along the direction from the second end 402 of each serial antenna unit 40, 40A toward the first end 401 of each serial antenna unit 40, 40A, and the sum of the current compensation values of the second radiating elements 423 is limited to approaching the sum of the original current values of the power divider 20, 20A, and the ground plane, which makes the current values of the radiation elements 42 of each serial antenna unit 40, 40A show an asymmetric distribution. Based on the above conditions, the main beam of the asymmetrical Chebyshev array antenna of the present invention has only one peak, and the directivity of the main beam increases (the maximum gain increases), and the gain of the side lobe decreases, thereby improving the resolution of the detection target rate.

In a preferred embodiment, as shown in FIG. 1, the asymmetrical Chebyshev array antenna of the present invention includes a plurality of power dividers 20, 20A, and the power divider 20 is configured with two serial antenna units 40, and the power divider 20A is configured with four serial antenna units 40A. The serial antenna unit 40 includes eight radiating elements 42, and the serial antenna unit 40A includes six radiating elements 42. However, the number of serial antenna units 40 and 40A configured in each power divider 20 and 20A is only exemplary, and the number of radiating elements 42 of each serial antenna unit 40 is also only exemplary; the actual number is not limited herein.

The following describes the relationship between the original current value and the compensated current value of the power divider 20, the ground plane, and the radiating elements 42 of the serial antenna units 40 and 40A.

As shown in FIGS. 1 and 2, the radiating elements 42 of the serial antenna unit 40 include two middle radiating elements 421, three first radiating elements 422, and three second radiating elements 423. The original current values of the first radiating elements 422 along the direction from the first end 401 of each serial antenna unit 40 to the second end 402 of each serial antenna unit 40 are sequentially defined as B₁, B₂, B₃, the original current values of the second radiating elements 423 along the direction from the second end 402 of each serial antenna unit 40 to the first end 401 of each serial antenna unit 40 and are sequentially defined as C₁, C₂, C₃, and the current compensation values of the second radiating elements 423 from the second end 402 of each serial antenna unit 40 to the first end 401 of each serial antenna unit 40 are sequentially defined as δ₁, δ₂, δ₃, and n=3.

Table 1 shows the relationship between the original current value and the compensated current value of the power divider 20, the ground plane, and the radiating elements 42 of the serial antenna units 40.

TABLE 1

| | Original | Compensated |
|---|---|---|
| | current value | current value |
| Power divider 20 and ground plane | D | D |
| First radiating element 422 | B₁ | B₁ |
| First radiating element 422 | B₂ | B₂ |
| First radiating element 422 | B₃ | B₃ |
| Middle radiating element 421 | A | A |
| Middle radiating element 421 | A | A |
| Second radiating element 423 | C₃ | C₃ + δ₃ |
| Second radiating element 423 | C₂ | C₂ + δ₂ |
| Second radiating element 423 | C₁ | C₁ + δ₁ |

The relationship of the original current values of the first radiating elements 422 and the original current values of the second radiating elements 423 is as follows: B₁=C₁, B₂=C₂, and B₃=C₃. The relationship of the sum of the original current values of the power divider 20 and the ground plane, the original current values of the first radiating elements 422, and the original current value of the at least one middle radiating element 421 is as follows: D<B₁<B₂<B₃<A. The relationship of the sum of the original current value of the power divider 20 and the ground plane, the compensated current values of the second radiating elements 423, and the original current value of the at least one middle radiating element 421 is as follows: D<C₁+δ₁<C₂+δ₂<C₃+δ₃<A. The relationship of the sum of the original current values of the power divider 20 and the ground plane and the current compensation values of the second radiating elements 423 is as follows:

$${\sum }_{i = 1}^{3} {δ}_{i} = {δ}_{1} + {δ}_{2} + {δ}_{3} ≅ D .$$

Preferably, as shown in FIG. 2, the area of the middle radiating elements 421 is the largest, and the areas of the first radiating elements 422 gradually increase along the direction from the first end 401 of each serial antenna unit 40 to the second end 402 of each serial antenna unit 40, and the areas of the second radiating elements 423 gradually increases along the direction from the second end 402 of each serial antenna unit 40 to the first end 401 of each serial antenna unit 40. The current values of the radiation elements 42 are proportional to the areas of the radiation elements 42. The current compensation values of the second radiation elements 423 are obtained by adjusting the areas of the second radiation elements 423.

Preferably, as shown in FIG. 2, each radiating element 42 is rectangular, a length of each radiating element 42 is parallel to a length direction u of each serial antenna unit 40, and a width of each radiating element 42 is parallel to a width direction v of each serial antenna unit 40. The current compensation values of the second radiation elements 423 can be obtained by adjusting the widths of the second radiation elements 423 to adjust the areas of the second radiation elements 423. More specifically, adjusting the widths of the second radiating elements 423 will not affect the distance between the two adjacent serial antenna units 40, thus will not destroy the phase. Although adjusting the lengths of the second radiating elements 423 can also achieve the effect of adjusting the areas of the second radiating elements 423, and can also obtain the current compensation values of the second radiating elements 423, but the distance between the two adjacent serial antenna unit 40 would be less than one-half of the wavelength of the operating frequency band, thus destroying the phase. Based on the above reasons, it is more appropriate to adjust the widths of the second radiating elements 423 than to adjust the lengths of the second radiating elements 423.

As shown in FIG. 1 and FIG. 3, the serial antenna unit 40A includes two middle radiating elements 421, two first radiating elements 422, and two second radiating elements 423. The original current values of the first radiating elements 422 along the direction from the first end 401 of each serial antenna unit 40A to the second end 402 of each serial antenna unit 40A are sequentially defined as B₁, B₂, the original current values of the second radiating elements 423 along a direction from the second end 402 of each serial antenna unit 40A to the first end 401 of each serial antenna unit 40A and are sequentially defined as C₁, C₂, and the current compensation values of the second radiating elements 423 from the second end 402 of each serial antenna unit 40A to the first end 401 of each serial antenna unit 40A are sequentially defined as δ₁, δ₂, and n=2.

Table 2 shows the relationship between the original current value and the compensated current value of the power divider 20A, the ground plane, and the radiating elements 42 of the serial antenna units 40A.

TABLE 2

| | Original | Compensated |
|---|---|---|
| | current value | current value |
| Power divider 20A and ground plane | D | D |
| First radiating element 422 | B₁ | B₁ |
| First radiating element 422 | B₂ | B₂ |
| Middle radiating element 421 | A | A |
| Middle radiating element 421 | A | A |
| Second radiating element 423 | C₃ | C₃ + δ₃ |
| Second radiating element 423 | C₂ | C₂ + δ₂ |

The relationship of the original current values of the first radiating elements 422 and the original current values of the second radiating elements 423 is as follows: B₁=C₁ and B₂=C₂. The relationship of the sum of the original current values of the power divider 20A and the ground plane, the original current values of the first radiating elements 422 and the original current value of the at least one middle radiating element 421 is as follows: D<B₁<B₂<A. The relationship of the sum of the original current value of the power divider 20A and the ground plane, the compensated current values of the second radiating elements 423, and the original current value of the at least one middle radiating element 421 is as follows: D<C₁+δ₁<C₂+δ<A. The relationship of the sum of the original current values of the power divider 20A and the ground plane and the current compensation values of the second radiating elements 423 is as follows:

$${\sum }_{i = 1}^{2} {δ}_{i} = {δ}_{1} + {δ}_{2} ≅ D .$$

Preferably, as shown in FIG. 3, the area of the middle radiating elements 421 is the largest, and the areas of the first radiating elements 422 gradually increase along the direction from the first end 401 of each serial antenna unit 40A to the second end 402 of each serial antenna unit 40A, and the areas of the second radiating elements 423 gradually increases along the direction from the second end 402 of each serial antenna unit 40A to the first end 401 of each serial antenna unit 40A. The current values of the radiation elements 42 are proportional to the areas of the radiation elements 42. The current compensation values of the second radiation elements 423 are obtained by adjusting the areas of the second radiation elements 423.

Preferably, as shown in FIG. 3, each radiating element 42 is rectangular, a length of each radiating element 42 is parallel to a length direction u of each serial antenna unit 40A, and a width of each radiating element 42 is parallel to a width direction v of each serial antenna unit 40A. The current compensation values of the second radiation elements 423 can be obtained by adjusting the widths of the second radiation elements 423 to adjust the areas of the second radiation elements 423. More specifically, adjusting the widths of the second radiating elements 423 will not affect the distance between the two adjacent serial antenna units 40A, thus will not destroy the phase. Although adjusting the lengths of the second radiating elements 423 can also achieve the effect of adjusting the areas of the second radiating elements 423, and can also obtain the current compensation values of the second radiating elements 423, but the distance between the two adjacent serial antenna unit 40A would be less than one-half of the wavelength of the operating frequency band, thus destroying the phase. Based on the above reasons, it is more appropriate to adjust the widths of the second radiating elements 423 than to adjust the lengths of the second radiating elements 423.

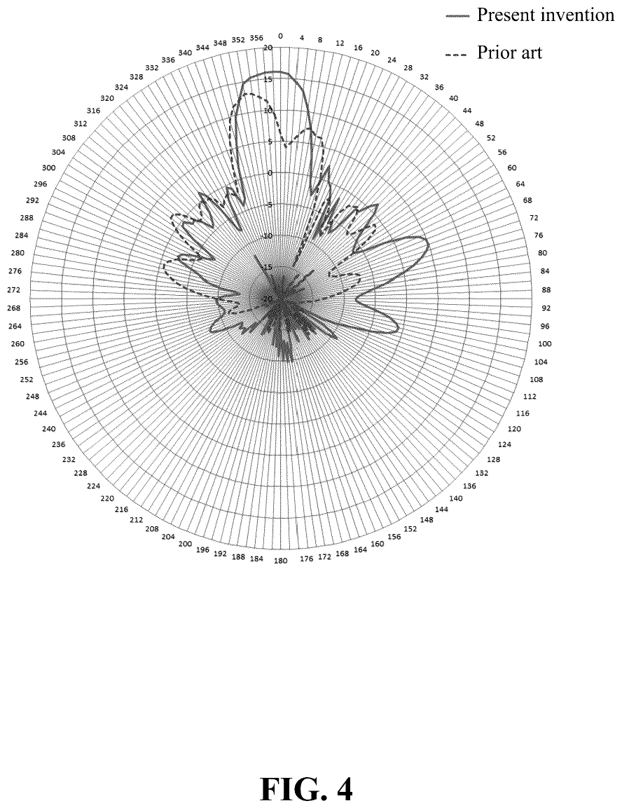

FIG. 4 is a radiation pattern diagram of an idealized array antenna of the prior art and an asymmetric Chebyshev array antenna of the present invention. The serial antenna unit of the idealized array antenna of the prior art has the same number of the radiating elements 42 as the serial antenna units 40, 40A of the present invention, except for the following difference: the area and current value of the radiating elements of each serial antenna unit of the idealized array antenna of the prior art are symmetrically distributed, and the area and current value of the radiating elements 42 of the serial antenna units 40 and 40A of the present invention are asymmetrical distributed. As shown in FIG. 4, because the radiation effect of the power divider and the ground plane will severely destroy the radiation pattern of the idealized array antenna, the main beam of the radiation pattern has two peaks, and the directivity of the main beam decreases (maximum gain drops to 13.2 dB), and the gain of the side lobe rises to −7 dB, resulting in a decrease in the identification rate of object detection. As shown in FIG. 4, once the current values of the second radiating elements 423 of the serial antenna units 40 and 40A are compensated, the impact on the radiation pattern of the asymmetrical Chebyshev array antenna from the radiation effect of the power divider 20, 20A and the ground plane is minimal, so the main beam of the radiation pattern has only one peak, and the directivity of the main beam rises (that is, the maximum gain rises to 16.19 dB), and the gain of the side lobe down to −20 dB. Compared with the radiation pattern of the idealized array antenna of the prior art, the main beam of the radiation pattern of the asymmetrical Chebyshev array antenna of the present invention has only one peak, and the maximum gain of the main beam increases by about 2.99 dB, and the gain of the side lobe is reduced by about 13 dB, thereby improving the identification rate of object detection.

Although the present invention has been described with reference to the preferred embodiments thereof, it is apparent to those skilled in the art that a variety of modifications and changes may be made without departing from the scope of the present invention, which is intended to be defined by the appended claims.

What is claimed is:

1. An asymmetrical Chebyshev array antenna, comprising:
a substrate, having a first surface and a second surface, and the second surface being located on the opposite side of the first surface;
a power divider, disposed on the first surface of the substrate;
a ground plane, disposed on the second surface of the substrate; and
a plurality of serial antenna units, arranged at intervals on the first surface of the substrate, and each serial antenna unit comprising a plurality of feeding lines and a plurality of radiating elements, and the power divider and the radiating elements being connected in series through the feeding lines;
wherein, the end of each serial antenna unit close to the power divider is defined as a first end, and the end of each serial antenna unit away from the power divider is defined as a second end, and the radiating elements include at least one middle radiating element, a plurality of first radiating elements, and a plurality of second radiating elements, at least one middle radiating element is located in the middle of each of the serial antenna units, and the first radiating elements are located between the first end of each serial antenna units and the at least one middle radiating element, the second radiating elements are located between the second end of each serial antenna unit and the at least one middle radiating element;
wherein, an original current value of the at least one middle radiating element is defined as A, original current values of the first radiating elements gradually increase along a direction from the first end of each serial antenna unit to the second end of each serial antenna unit and are sequentially defined as B₁, B₂ . . . , Bₙ, original current values of the second radiating elements gradually increase along a direction from the second end of each serial antenna unit to the first end of each serial antenna unit and are sequentially defined as C₁, C₂ . . . , Cₙ, a sum of original current values of the power divider and the ground plane is defined as D, and current compensation values of the second radiating elements from the second end of each serial antenna unit to the first end of each serial antenna unit are sequentially defined as δ₁, δ₂, . . . , δₙ, where n≥1 and n is a positive integer; and
wherein, the relationship between the original current values of the first radiating elements and the original current values of the second radiating elements is as follows: Bₙ=Cₙ; the relationship of the sum of the original current values of the power divider and the ground plane, the original current values of the first radiating elements and the original current value of the at least one middle radiating element is as follows: D<B₁<B₁< . . . <Bₙ<A; the relationship of the sum of the original current values of the power divider and the ground plane, the compensated current values of the second radiating elements, and the original current value of the at least one middle radiating element is as follows: D<C₁+δ₁<C₂+δ₂< . . . <Cₙ+δₙ<A; the relationship of the sum of the original current values of the power divider and the ground plane and the current compensation values of the second radiating elements is as follows:
$${\sum }_{i = 1}^{n} {δ}_{i} = {δ}_{1} + {δ}_{2} + … + {δ}_{n} ≅ D .$$

2. The asymmetrical Chebyshev array antenna according to claim 1, wherein an area of the at least one middle radiating element is the largest, and areas of the first radiating elements gradually increase along a direction from the first end of each serial antenna unit to the second end of each serial antenna unit, areas of the second radiating elements gradually increases along a direction from the second end of each serial antenna unit to the first end of each of the serial antenna units, the current values of the radiating elements are proportional to the areas of the radiation elements; the current compensation values of the second radiation elements are controlled by adjusting the areas of the second radiation elements.

3. The asymmetrical Chebyshev array antenna according to claim 2, wherein each radiating element is rectangular, a length of each radiating element is parallel to a length direction of each serial antenna unit, and a width of each radiating element is parallel to a width direction of each serial antenna units; by adjusting the width of the second radiating elements to adjust the areas of the second radiating elements, the current compensation values of the second radiating elements can be obtained.

4. The asymmetrical Chebyshev array antenna according to claim 1, wherein the radiating elements comprise two middle radiating elements, three first radiating elements, and three second radiating elements; wherein, the original current values of the first radiating elements along the direction from the first end of each serial antenna unit to the second end of each serial antenna unit are sequentially defined as B₁, B₂, B₃, the original current values of the second radiating elements along a direction from the second end of each serial antenna unit to the first end of each serial antenna unit and are sequentially defined as C₁, C₂, C₃, and the current compensation values of the second radiating elements from the second end of each serial antenna unit to the first end of each serial antenna unit are sequentially defined as δ₁, δ₂, δ₃, and n=3; wherein the relationship of the original current values of the first radiating elements and the original current values of the second radiating elements is as follows: B₁=C₁, B₂=C₂, and B₃=C₃; wherein the relationship of the sum of the original current values of the power divider and the ground plane, the original current values of the first radiating elements, and the original current value of the at least one middle radiating element is as follows: D<B₁<B₂<B₃<A; wherein the relationship of the sum of the original current value of the power divider and the ground plane, the compensated current values of the second radiating elements, and the original current value of the at least one middle radiating element is as follows: D<C₁+δ₁<C₂+δ₂<C₃+δ₃<A; wherein the relationship of the sum of the original current values of the power divider and the ground plane and the current compensation values of the second radiating elements is as follows:
$${\sum }_{i = 1}^{3} {δ}_{i} = {δ}_{1} + {δ}_{2} + {δ}_{3} ≅ D .$$

5. The asymmetrical Chebyshev array antenna according to claim 1, wherein the radiating elements comprise two middle radiating elements, two first radiating elements, and two second radiating elements; wherein, the original current values of the first radiating elements along the direction from the first end of each serial antenna unit to the second end of each serial antenna unit are sequentially defined as B₁, B₂, the original current values of the second radiating elements along a direction from the second end of each serial antenna unit to the first end of each serial antenna unit and are sequentially defined as C₁, C₂, and the current compensation values of the second radiating elements from the second end of each serial antenna unit to the first end of each serial antenna unit are sequentially defined as δ₁, δ₂, and n=2; wherein the relationship of the original current values of the first radiating elements and the original current values of the second radiating elements is as follows: B₁=C₁ and B₂=C₂; wherein the relationship of the sum of the original current values of the power divider and the ground plane, the original current values of the first radiating elements, and the original current value of the at least one middle radiating element is as follows: D<B₁<B₂<A; wherein the relationship of the sum of the original current values of the power divider and the ground plane, the compensated current values of the second radiating elements, and the original current value of the at least one middle radiating element is as follows: D<C₁+δ₁<C₂+δ<A; wherein the relationship of the sum of the original current values of the power divider and the ground plane and the current compensation values of the second radiating elements is as follows:
$${\sum }_{i = 1}^{2} {δ}_{i} = {δ}_{1} + {δ}_{2} ≅ D .$$
